(19) United States
(12) Patent Application Publication
(10) Pub. No.: US 2015/0037148 A1
(43) Pub. Date: Feb. 5, 2015

(54) FAN AND MOTOR MECHANISM THEREOF

(71) Applicant: Cooler Master (Hui Zhou) Co., Ltd., Huizhou (CN)

(72) Inventors: Wei-Lung Chan, Huizhou (CN); Shiman Xu, Chaozhou C ity (CN); Yongwen Lai, Zijin County (CN)

(21) Appl. No.: 14/447,603

(22) Filed: Jul. 30, 2014

(30) Foreign Application Priority Data
Jul. 31, 2013 (CN) 201320465861.8

(51) Int. Cl. F04D 29/58; F04D 19/00; H02K 7/08

(52) U.S. Cl. CPC F04D 29/5806; H02K 7/08; F04D 19/002
USPC 415/220; 310/425

(57) ABSTRACT

A fan includes a motor mechanism and a plurality of fan blades. The motor mechanism includes a base, a bearing, a rotor and a stator. The base has an axial tube. The bearing is disposed in the axial tube. The rotor has an axle. The axle is inserted into the bearing and has a recess structure. The stator is sleeved on the axial tube and includes an upper insulated frame. The upper insulated frame has a resilient cantilever structure. The resilient cantilever structure is extended into the recess structure. The fan blades protrude from a periphery of the rotor.

### BACKGROUND OF THE INVENTION

1. Field of the Invention

The invention relates to a fan and a motor mechanism thereof and, more particularly, to a fan and a motor mechanism thereof utilizing an upper insulated frame of a stator to lock an axle of a rotor.

2. Description of the Prior Art

Heat dissipating device is a significant component for electronic products. When an electronic product is operating, the current in circuit will generate unnecessary heat due to impedance. If the heat is accumulated in the electronic components of the electronic product without dissipating immediately, the electronic components may get damage due to the accumulated heat. Therefore, the performance of heat dissipating device is a significant issue for the electronic product. So far the heat dissipating device used in the electronic product usually consists of a heat pipe, a heat dissipating fin and a fan, wherein a heat absorbing segment of the heat pipe contacts the electronic component, which generates heat during operation, a heat dissipating segment of the heat pipe is connected to the heat dissipating fin, and the fan blows air to the heat dissipating fin, so as to dissipate heat.

In general, the fan essentially consists of a motor mechanism including a base, a bearing, a rotor and a stator, and a plurality of fan blades protruding from a periphery of the rotor, wherein the bearing is disposed in an axial tube of the base, an axle of the rotor is inserted into the bearing, and the stator is sleeved on the axial tube. When the rotor is rotating, the rotor may come off the stator due to vibration resulted from high speed rotation, such that the fan may fail or other components within an electronic device may be damaged. In the prior art, a buckle member is disposed in the axial tube of the base of the conventional fan, so as to lock the axle of the rotor. However, after the fan works for a span of time, the buckle member may come off the rotor easily, such that the rotor may come off the stator due to vibration resulted from high speed rotation. Furthermore, an operator may forget to dispose the buckle member in the axial tube of the base, such that a defect exists in the fan after manufacture.

### SUMMARY OF THE INVENTION

The invention provides a fan and a motor mechanism thereof utilizing an upper insulated frame of a stator to lock an axle of a rotor, so as to solve the aforesaid problems.

According to an embodiment of the invention, a fan comprises a motor mechanism and a plurality of fan blades. The motor mechanism comprises a base, a bearing, a rotor and a stator. The base has an axial tube. The bearing is disposed in the axial tube. The rotor has an axle. The axle is inserted into the bearing and has a recess structure. The stator is sleeved on the axial tube and comprises an upper insulated frame. The upper insulated frame has a resilient cantilever structure. The resilient cantilever structure is extended into the recess structure. The fan blades protrude from a periphery of the rotor.

According to another embodiment of the invention, a motor mechanism comprises a base, a bearing, a rotor and a stator. The base has an axial tube. The bearing is disposed in the axial tube. The rotor has an axle. The axle is inserted into the bearing and has a recess structure. The stator is sleeved on the axial tube and comprises an upper insulated frame. The upper insulated frame has a resilient cantilever structure. The resilient cantilever structure is extended into the recess structure.

As mentioned in the above, the invention adds the resilient cantilever structure onto the upper insulated frame of the stator. When the axle of the rotor is inserted into the bearing, the resilient cantilever structure of the upper insulated frame is extended into the recess structure of the axle accordingly, such that the rotor is locked with the stator, so as to prevent the rotor from coming off the stator. Furthermore, the resilient cantilever structure of the upper insulated frame, which is extended into the recess structure of the axle, can further prevent lubricating oil between the bearing and the axle from oozing and prevent particles from entering a gap between the bearing and the axle. Moreover, since the invention utilizes the upper insulated frame of the stator to lock the axle of the rotor, the buckle member of the prior art is unnecessary for the invention. Accordingly, the invention can prevent the defect resulted from the lack of the buckle member during assembly process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a fan according to a first embodiment of the invention.

FIG. 2 is an exploded view illustrating the fan shown in FIG. 1.

FIG. 3 is an exploded view illustrating the fan 1 shown in FIG. from another viewing angle.

FIG. 4 is a cross-sectional view illustrating the fan shown in FIG. 1 along line A-A.

FIG. 5 is a schematic view illustrating an assembly process of the axle and the upper insulated frame shown in FIG. 4.

FIG. 6 is a cross-sectional view illustrating a fan according to a second embodiment of the invention.

### DETAILED DESCRIPTION

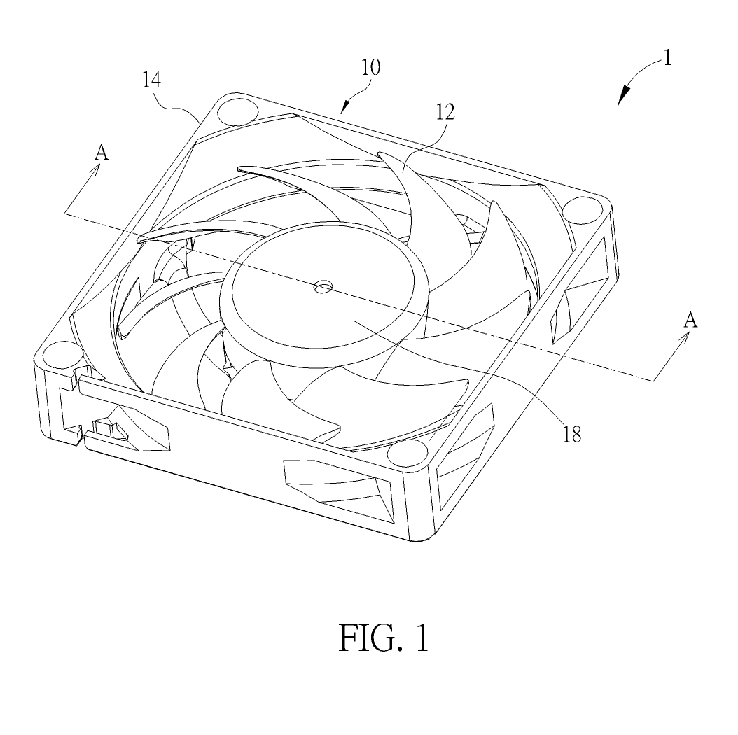

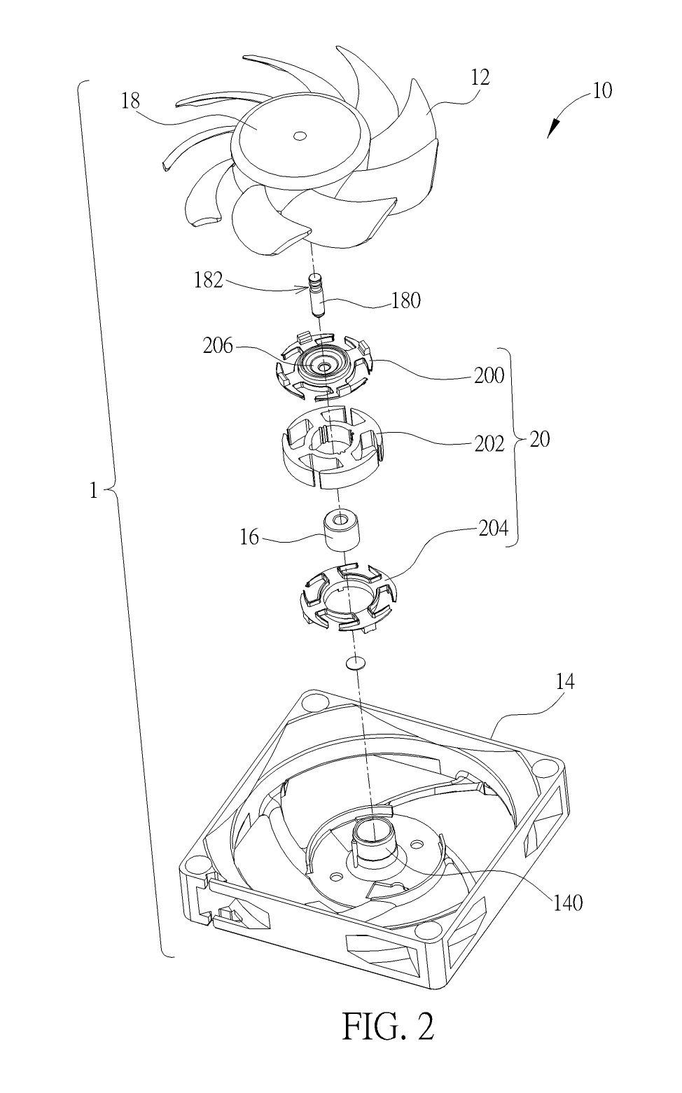

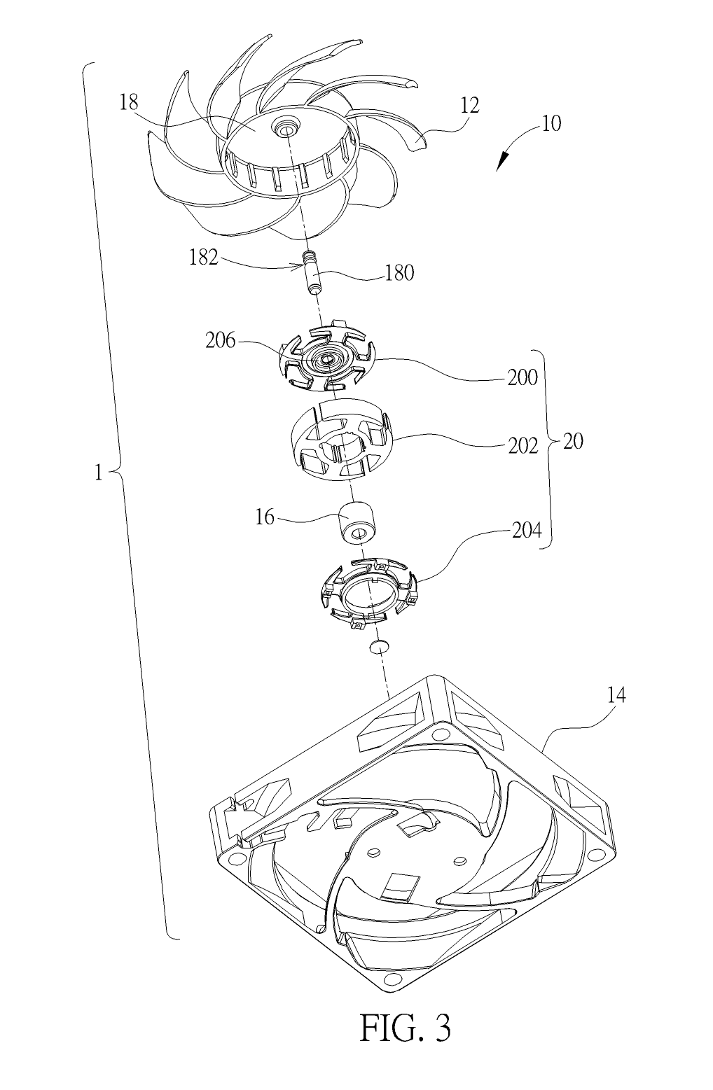

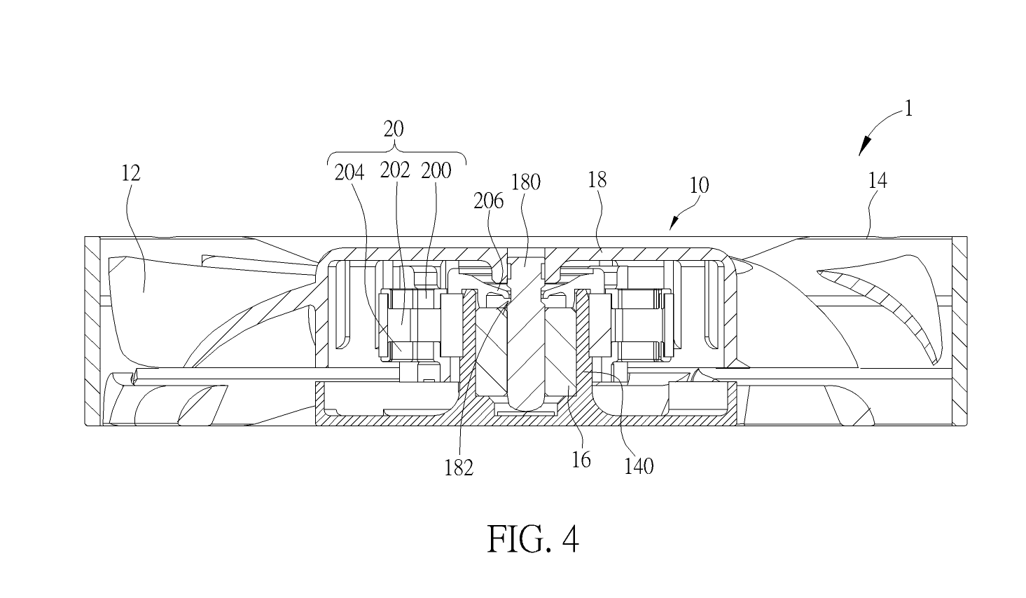

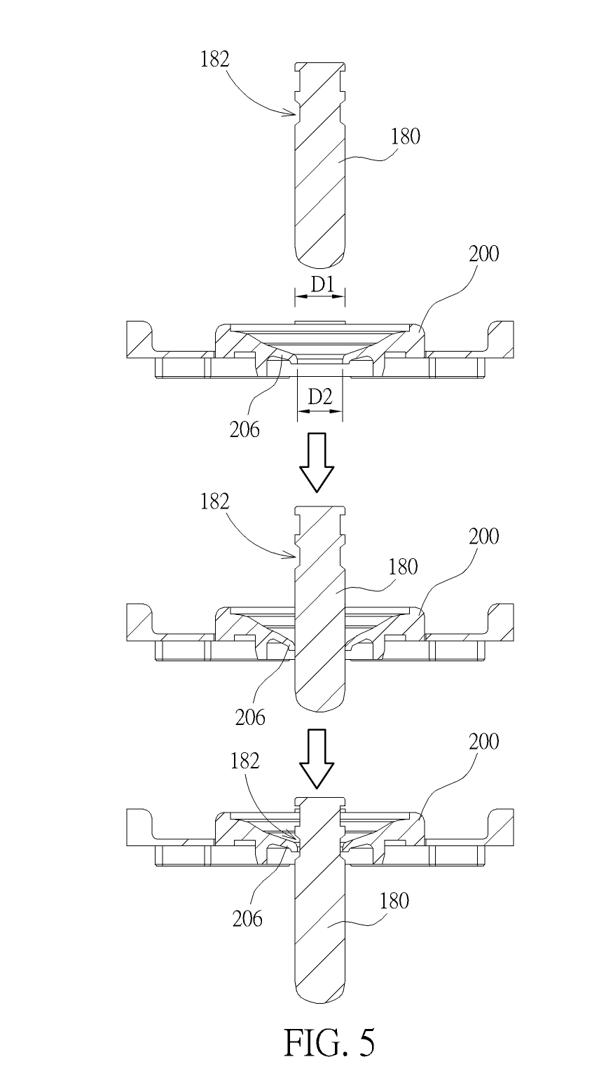

Referring to FIGS. 1 to 5, FIG. 1 is a perspective view illustrating a fan 1 according to a first embodiment of the invention, FIG. 2 is an exploded view illustrating the fan 1 shown in FIG. 1, FIG. 3 is an exploded view illustrating the fan 1 shown in FIG. 1 from another viewing angle, FIG. 4 is a cross-sectional view illustrating the fan 1 shown in FIG. 1 along line A-A, and FIG. 5 is a schematic view illustrating an assembly process of the axle 180 and the upper insulated frame 200 shown in FIG. 4.

As shown in FIGS. 1 to 4, the fan 1 comprises a motor mechanism 10 and a plurality of fan blades 12. The motor mechanism 10 comprises a base 14, a bearing 16, a rotor 18 and a stator 20. The base 14 has an axial tube 140. The bearing 16 is disposed in the axial tube 140. The fan blades 12 protrude from a periphery of the rotor 18. The rotor 18 has an axle 180. The axle 180 is fixed on a center of the rotor 18 and inserted into the bearing 16. The axle 180 has a recess structure 182. In this embodiment, the recess structure 182 is a ring-shaped recess around the axle 180. The stator 20 is sleeved on the axial tube 140. The stator 20 has an upper insulated frame 200, a silicon steel sheet assembly 202 and a lower insulated frame 204. The silicon steel sheet assembly 202 is sandwiched in between the upper insulated frame 200 and the lower insulated frame 204, wherein the silicon steel sheet assembly 202 essentially consists of a plurality of silicon steel sheets stacked with each other. In practical applications, a metal coil (not shown) is wound around the teeth of the upper insulated frame 200, the silicon steel sheet assembly 202 and the lower insulated frame 204. The upper insulated frame 200 has a resilient cantilever structure 206. In this embodiment, the upper insulated frame 200 and the resilient cantilever structure 206 are formed integrally to be a one-piece structure.

To assemble the fan 1, the stator 20 is sleeved on the axial tube 140 of the base 14 and the bearing 16 is disposed in the axial tube 140 in the beginning. Afterwards, the axle 180 of the rotor 18 is inserted into the bearing 16. When the axle 180 of the rotor 18 is inserted into the bearing 16, the resilient cantilever structure 206 of the upper insulated frame 200 is extended into the recess structure 182 of the axle 180 accordingly, such that the rotor 18 is locked with the stator 20, so as to prevent the rotor 18 from coming off the stator 20.

In this embodiment, the resilient cantilever structure 206 is ring-shaped, and an external diameter D1 of the axle 180 is larger than an internal diameter D2 of the resilient cantilever structure 206. As shown in FIG. 5, when the axle 180 of the rotor 18 is inserted downward into a hole formed on the center of the resilient cantilever structure 206 of the upper insulated frame 200, the axle 180 will deform the resilient cantilever structure 206 downward since the external diameter D1 of the axle 180 is larger than the internal diameter D2 of the resilient cantilever structure 206. After the axle 180 is inserted to the end, the resilient cantilever structure 206 will be extended into the recess structure 182 of the axle 180, such that the rotor 18 is locked with the stator 20.

In addition to the purpose of preventing the rotor 18 from coming off the stator 20, the resilient cantilever structure 206, which is extended into the recess structure 182 of the axle 180, can further prevent lubricating oil between the bearing 16 and the axle 180 from oozing and prevent particles from entering a gap between the bearing 16 and the axle 180. Moreover, since the invention utilizes the upper insulated frame 200 of the stator 20 to lock the axle 180 of the rotor 18, the buckle member of the prior art is unnecessary for the invention. Accordingly, the invention can prevent the defect resulted from the lack of the buckle member during assembly process.

It should be noted that, in addition to the fan, the motor mechanism 10 of the invention can be further applied to other electronic devices equipped with a motor. That is to say, the scope of the invention is not limited to the fan.

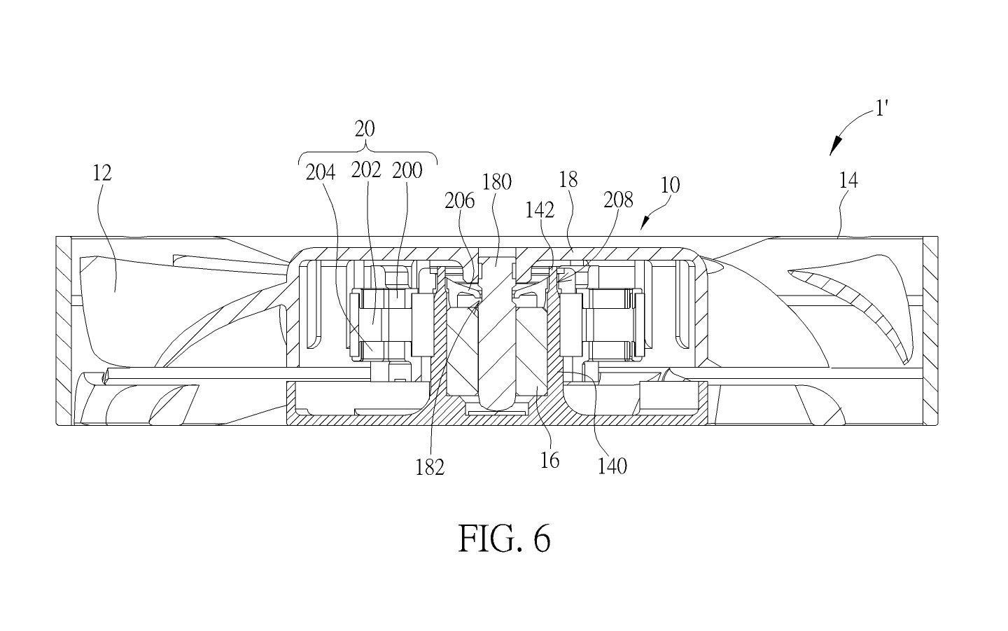

Referring to FIG. 6 along with FIG. 4, FIG. 6 is a cross-sectional view illustrating a fan 1′ according to a second embodiment of the invention. The difference between the fan 1′ and the aforesaid fan 1 is that the upper insulated frame 200 of the fan 1′ has a plurality of fixing holes 208 and an end of the axial tube 140 of the fan 1′ has a plurality of fixing portions 142. When the stator 20 is sleeved on the axial tube 140 of the base 14, each of the fixing portions 142 can pass through one of the fixing holes 208 correspondingly. Then, the fixing portions 142 may be fixed in the fixing holes 208 in a melting manner, so as to enhance the connection strength between the stator 20 and the axial tube 140 of the base 14. It should be noted that the same elements in FIG. 6 and FIG. 4 are represented by the same numerals, so the repeated explanation will not be depicted herein again.

As mentioned in the above, the invention adds the resilient cantilever structure onto the upper insulated frame of the stator. When the axle of the rotor is inserted into the bearing, the resilient cantilever structure of the upper insulated frame is extended into the recess structure of the axle accordingly, such that the rotor is locked with the stator, so as to prevent the rotor from coming off the stator. Furthermore, the resilient cantilever structure of the upper insulated frame, which is extended into the recess structure of the axle, can further prevent lubricating oil between the bearing and the axle from oozing and prevent particles from entering a gap between the bearing and the axle. Moreover, since the invention utilizes the upper insulated frame of the stator to lock the axle of the rotor, the buckle member of the prior art is unnecessary for the invention. Accordingly, the invention can prevent the defect resulted from the lack of the buckle member during assembly process. Still further, the invention may further add the fixing holes and the fixing portions onto the upper insulated frame and the axial tube of the base correspondingly and then fix the fixing portions in the fixing holes in the melting manner, so as to enhance the connection strength between the stator and the axial tube of the base.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fan comprising:
a motor mechanism comprising:
a base having an axial tube;
a bearing disposed in the axial tube;
a rotor having an axle, the axle being inserted into the bearing and having a recess structure; and
a stator sleeved on the axial tube, the stator comprising an upper insulated frame, the upper insulated frame having a resilient cantilever structure, the resilient cantilever structure being extended into the recess structure; and
a plurality of fan blades protruding from a periphery of the rotor.

2. The fan of claim 1, wherein the stator further comprises a silicon steel sheet assembly and a lower insulated frame, and the silicon steel sheet assembly is sandwiched in between the upper insulated frame and the lower insulated frame.

3. The fan of claim 1, wherein the resilient cantilever structure is ring-shaped, and an external diameter of the axle is larger than an internal diameter of the resilient cantilever structure.

4. The fan of claim 1, wherein the upper insulated frame has a plurality of fixing holes formed thereon, an end of the axial tube has a plurality of fixing portions, and the fixing portions are fixed in the fixing holes in a melting manner.

5. A motor mechanism comprising:
a base having an axial tube;
a bearing disposed in the axial tube;
a rotor having an axle, the axle being inserted into the bearing and having a recess structure; and
a stator sleeved on the axial tube, the stator comprising an upper insulated frame, the upper insulated frame having a resilient cantilever structure, the resilient cantilever structure being extended into the recess structure.

6. The motor mechanism of claim 5, wherein the stator further comprises a silicon steel sheet assembly and a lower insulated frame, and the silicon steel sheet assembly is sandwiched in between the upper insulated frame and the lower insulated frame.

7. The motor mechanism of claim 5, wherein the resilient cantilever structure is ring-shaped, and an external diameter of the axle is larger than an internal diameter of the resilient cantilever structure.

8. The motor mechanism of claim 5, wherein the upper insulated frame has a plurality of fixing holes formed thereon, an end of the axial tube has a plurality of fixing portions, and the fixing portions are fixed in the fixing holes in a melting manner.
